(19) United States
(12) Patent Application Publication
(10) Pub. No.: US 2026/0235809 A1
(43) Pub. Date: Aug. 13, 2026

(54) Spot-Size Converter for High Optical Input Power

(71) Applicant: Ciena Corporation, Hanover, MD (US)

(72) Inventor: Marie-Josée Picard, L’Ancienne-Lorette (CA)

(73) Assignee: Ciena Corporation, Hanover, MD (US)

(21) Appl. No.: 19/330,924

(22) Filed: Sep. 17, 2025

Related U.S. Application Data
(60) Provisional application No. 63/756,717, filed on Feb. 10, 2025.

(51) Int. Cl. G02B 6/122; G02B 6/12

(52) U.S. Cl. CPC G02B 6/1228; G02B 6/12004; G02B 2006/12061; G02B 2006/1215; G02B 2006/12152; G02B 2006/12159; G02B 2006/12164

(57) ABSTRACT

A photonics device includes a spot-size converter (SSC) with an integrated splitter positioned at or near a chip facet to couple high-power optical signals into submicron waveguides. The splitter adiabatically divides an incoming optical signal into multiple sub-signals, thereby reducing per-branch optical power and generating multiple usable copies for downstream photonic components. A waveguide separation section spatially routes the sub-signals, and an SSC transfers each sub-signal from a guiding region into a waveguide through an adiabatic transition. Embodiments include three-rod geometries, thin SiN layers, multi-layer or bridge configurations, and operation in transverse magnetic (TM) polarization to increase the effective mode area and raise the damage threshold. Multi-stage or single-stage splitters can provide 1×2, 1×4, or higher-order divisions, enabling robust coupling of laser inputs above 20 dBm while maintaining low insertion loss and preventing nonlinear absorption, thermal accumulation, or permanent material damage.

### CROSS-REFERENCE TO RELATED APPLICATION(S)

The present disclosure claims priority to U.S. Patent Application No. 63/756,717, filed Feb. 10, 2025, the contents of which are incorporated by reference in their entirety.

### FIELD OF THE DISCLOSURE

The present disclosure relates generally to photonics devices. More particularly, the present disclosure relates to a spot-size converter for high optical input power such as in silicon photonics.

### BACKGROUND OF THE DISCLOSURE

A spot-size converter (SSC) in silicon photonics is a transitional waveguide structure configured to couple light efficiently between two optical waveguides whose guided modes differ significantly in size. A common example is the coupling between a submicron silicon waveguide on a photonic integrated circuit (PIC) and the larger optical mode of an optical fiber. Conventional SSCs typically employ a lower waveguiding element, such as silicon, that tapers along its length to gradually modify its effective refractive index. An upper waveguiding structure, formed from one or more rows or sheets of a higher-index material, is positioned above the lower waveguide to support and guide the optical mode. By carefully designing these elements such that their effective indices intersect within a defined coupling region, the SSC provides a gradual, low-loss transfer of light between mismatched waveguide modes. This design mitigates the inherent mismatch between the tightly confined mode in silicon photonic circuits and the comparatively larger mode field of external fibers or waveguides, thereby enhancing coupling efficiency, reducing insertion losses, and maintaining compactness and compatibility with integrated photonic platforms.

### BRIEF SUMMARY OF THE DISCLOSURE

The present disclosure relates to spot-size converters configured for high optical input power in silicon photonics devices. Conventional SSCs are limited by nonlinear absorption, thermal accumulation, and material damage when coupling laser inputs above approximately 20 dBm into submicron silicon waveguides. To overcome these limitations, the disclosed SSC architectures integrate a splitter positioned at or near a chip facet to divide the input beam into multiple lower-power sub-signals. This approach simultaneously reduces the local optical intensity and produces multiple usable copies of the signal for downstream components. The SSC further incorporates features such as thin silicon nitride (SiN) guiding layers, multi-rod or bridge waveguides, multi-layer SiN structures, and TM polarization operation, each of which broadens the effective mode area and elevates the damage threshold. Embodiments include 1×2, 1×4, and higher-order splitters, implemented in single-stage or cascaded geometries, enabling robust operation with input powers exceeding 20-26 dBm while maintaining low insertion loss and reliable coupling into silicon photonic circuits.

### BRIEF DESCRIPTION OF THE DRAWINGS

The present disclosure is detailed through various drawings, where like components or steps are indicated by identical reference numbers for clarity and consistency.

FIG. 1 is a schematic diagram of a silicon photonics chip including a facet-level splitter implemented in a single silicon nitride (SiN) layer, showing a three-rod geometry that adiabatically divides an incoming optical beam into two outputs before transfer into silicon.

FIG. 2 is a schematic diagram of the chip of FIG. 1 further illustrating representative tolerance performance at the facet, with inset coupling profiles showing how lateral beam misalignments affect splitting ratio and insertion loss in the three-rod design.

FIG. 3 is a schematic diagram of an embodiment employing two stacked SiN layers for the splitter and spot-size converter, enabling broader mode distribution and improved power handling relative to the single-layer design.

FIG. 4 is a schematic diagram of an embodiment similar to FIG. 3 but with a modified SiN-to-Si transfer section, in which the two SiN layers taper at different rates to alter the adiabatic coupling dynamics into the silicon waveguide.

FIG. 5 is a schematic diagram of an embodiment further incorporating a thicker SiN “bridge” layer in the transfer section, providing an intermediate index step for enhanced mode size control, refractive index engineering, and higher damage threshold.

FIG. 6 is a schematic close-up view of the facet region of the chip, illustrating the three-rod splitter geometry and waveguide separation section that immediately divides the incoming optical mode into two outputs for robust, low-loss operation under high-power conditions.

FIG. 7 is a schematic diagram of a small mode-field diameter spot-size converter without an integrated splitter, showing a three-rod thin-SiN design that expands and transfers the optical mode into silicon while reducing local intensity and increasing the damage threshold.

FIG. 8 is a schematic diagram of a silicon photonics chip including a cascaded two-stage 1×4 splitter, showing how an input beam is divided into four outputs through successive adiabatic splitting stages, with subsequent SiN-to-Si transfer into silicon waveguides for reduced per-branch power and multiple identical signal copies.

FIG. 9 is a schematic diagram of a silicon photonics chip including a two-stage 1×4 splitter in which all adjacent waveguides are present at the first stage entrance, enabling smoother mode evolution, reduced perturbation, and balanced power distribution into four silicon waveguides.

FIG. 10 is a schematic diagram of a silicon photonics chip including a single-stage 1×4 splitter that directly divides an input optical beam into four balanced outputs at the chip facet, with subsequent SiN-to-Si transfer into silicon waveguides for compact high-power signal distribution.

FIG. 11 is a flowchart of a process for operating a high-power spot-size converter in a silicon photonics device, illustrating steps including providing a >20 dBm laser input, adjusting beam size and polarization, injecting the light into a facet-level splitter, routing through SiN separation waveguides, performing adiabatic mode transfer, and propagating the reduced-power signals into silicon photonic components.

### DETAILED DESCRIPTION OF THE DISCLOSURE

High-power laser inputs in the range of approximately 20 dBm to 26 dBm present a substantial challenge in silicon photonics due to the high optical intensities that result when coupling large-mode-field beams into submicron silicon waveguides. Excessive power density can induce material damage, nonlinear absorption effects (such as two-photon absorption), and thermal failures. To address these limitations, the present disclosure describes spot-size converter architectures that incorporate thin silicon nitride (SiN) layers (e.g., less than 100 nm), multi-rod or bridge-type waveguide structures, and tailored mode expansions (including the use of transverse magnetic (TM) polarization) to distribute optical power over a larger cross-section. By lowering peak intensities and mitigating localized confinement, these designs have been demonstrated to sustain input levels exceeding 22.5 dBm without failure.

In addition to optimized SSC geometries, several coupling schemes are disclosed to further enhance the power handling capability of SiPhot devices. In one embodiment, a free-space lens system provides direct laser-to-chip coupling, enabling beam size adjustment, integration of optical isolation elements, and polarization rotation into the TM mode. In another embodiment, a fiber-based approach employs a high-numerical-aperture (HNA) fiber spliced to a polarization-maintaining (PM) fiber to deliver similar control and robustness. Further, an on-chip splitter positioned at the input facet can immediately divide the coupled optical power (e.g., 50/50 or another ratio), thereby reducing downstream power density by approximately 3 dB or more. Collectively, these approaches increase the SSC's damage threshold, maintain efficient mode conversion, and ensure low insertion loss, making the disclosed designs well suited for high-power datacom and telecom links as well as next-generation coherent optical systems.

### SSC Use Cases

High-power spot-size converters in silicon photonics are typically employed in advanced optical transmission modules and transceivers that must accommodate laser outputs in the 20 dBm range or higher when coupling into submicron silicon waveguides. This requirement is increasingly critical for next-generation data-center and telecom devices, including but not limited to the following applications:
(1) 2×800 LR Transceivers—These systems require elevated laser output powers to compensate for insertion losses from modulators and propagation losses over extended link distances in data-center interconnects, thereby ensuring sufficient optical power at the receiver.
(2) High-Bandwidth Transmitter (Tx) Modules (e.g., 400G, 800G, and beyond)—In such modules, higher input laser powers facilitate efficient driving of electro-optic modulators at elevated baud rates, supporting signal fidelity and maintaining link budgets for next-generation bandwidth demands.
(3) Advanced Coherent Optics—Emerging coherent transceiver architectures are considering laser sources in the 20-26 dBm range to meet future standards, support higher-order modulation formats, and achieve extreme data rates with stringent signal-to-noise ratio (SNR) requirements.

In each of these scenarios, the SSC is configured to provide an adiabatic or near-adiabatic expansion and contraction of the optical mode profile. By expanding the optical field into a larger cross-section or through an intermediary waveguide layer prior to confinement in the silicon core, the SSC reduces peak optical intensity, thereby mitigating two-photon absorption, nonlinear loss, and thermal accumulation. As a result, the SSC prevents permanent damage and excessive insertion loss, even under sustained input powers exceeding 20 dBm.

For high-optical-power applications, the dense modal confinement inherent to silicon photonics presents significant challenges. When light from a high-brightness single-mode fiber (SMF)—often a polarization-maintaining (PM) fiber—is coupled into a spot-size converter, the optical mode undergoes progressive compression as it transitions toward the submicron silicon waveguide core. This concentration of optical energy raises the local power density, particularly within the final tapered region of the SSC where the mode is most tightly confined. Elevated power density increases the likelihood of material damage mechanisms, including localized heating, multiphoton absorption, and permanent refractive-index modification, any of which can degrade performance or result in catastrophic device failure. These effects are exacerbated at input powers exceeding 20 dBm, where even minor fabrication imperfections or material inhomogeneities can act as failure initiation sites. Accordingly, high-power coupling demands SSC architectures that are specifically engineered to redistribute or expand the optical field, thereby lowering peak intensities before the mode is delivered into the silicon core.

In one embodiment, the SSC architecture, described in U.S. Pat. No. 9,703,047, issued Jul. 11, 2017, and entitled “Spot-size converter for optical mode conversion and coupling between two waveguides,” the contents of which are hereby incorporated by reference in their entirety, uses a multi-rod structure (MRS) of silicon nitride (SiN) to expand or reshape the input beam prior to coupling it into a silicon taper. Light can transition either directly from the MRS to the silicon taper, or via a single SiN “bridge” waveguide section, which offers further control over the effective mode index. Experimental testing to assess the damage threshold of such SSCs has shown that sustained optical powers above approximately 20 dBm can produce irreversible defects in certain designs.

Accordingly, to meet emerging requirements for high-power operation in the 20 dBm to 26 dBm range, and potentially higher for future data-center, telecom, and coherent optical systems, enhanced SSC designs and power-management strategies are required. Conventional spot-size converters optimized for lower input powers are insufficient, as they are prone to nonlinear absorption, thermal accumulation, and physical damage when subjected to sustained high-brightness inputs. By re-engineering the waveguide geometry (for example, employing thinner silicon nitride (SiN) layers, multi-rod or bridge-type structures, or cascaded taper sections), tailoring the supported mode shape (e.g., expanding into the cladding or leveraging TM polarization), and incorporating auxiliary functions such as on-chip splitting, staged splitting-and-isolation, or power equalization directly at the chip facet, the SSC can distribute optical energy over a larger effective area. These measures reduce localized intensity, mitigate nonlinear effects, and extend the power-handling capacity of the SSC well beyond 26 dBm, while preserving low insertion loss and efficient mode conversion.

### Key Insights

A comprehensive investigation of optical mode distribution and localized power density within spot-size converters employing multi-rod structures has been conducted. This study combined numerical simulations with experimental validation, including stress testing under high-power illumination. Prototypes were fabricated and evaluated for both single-step transitions (multi-rod silicon nitride (SiN) to silicon (Si)) and two-step transitions (multi-rod SiN to SiN bridge to Si). The results provide a detailed understanding of how optical energy is confined, redistributed, and dissipated across the different material layers and geometries. From this investigation, four key insights have been derived regarding the management of high-power coupling in SiN and Si waveguides. These insights address not only the limits imposed by damage thresholds but also the onset of nonlinear loss mechanisms, offering practical design strategies to extend SSC performance for input powers in the 20-26 dBm range and beyond. Specifically, these insights are noted as follows:
(1) Silicon Nitride (SiN) exhibits greater fragility under high-power illumination than Silicon (Si). Experimental data confirm that continuous-wave optical inputs above approximately 20 dBm can induce irreversible damage in SiN waveguides more readily than in Si. This vulnerability is attributed to SiN's lower thermal conductivity, wider bandgap, and a higher density of defect states that can localize energy and initiate damage. When optical modes are tightly confined within SiN, localized heating and defect activation can lead to permanent structural degradation such as refractive index shifts, cracks, or burns. By contrast, silicon waveguides exhibit greater resilience to comparable intensity levels, underscoring the importance of managing the proportion of optical energy confined in SiN layers.
(2) Thinner SiN guiding layers (<100 nm) reduce peak power density. Reducing the thickness of the SiN guiding layer, e.g., typically from 200 nm or greater down to below 100 nm, expands the optical mode laterally and vertically into the cladding region. This reduces the proportion of optical energy confined in the high-index SiN core and lowers the localized power density. Both simulations and experimental testing demonstrate that thinner SiN layers significantly elevate the optical damage threshold by minimizing hot spots within the material. The reduced confinement enables the SSC to tolerate sustained input powers above 22 dBm before transitioning the mode into the final silicon taper.
(3) TM-polarized modes in thin SiN waveguides further broaden the effective area. When propagating in thin SiN layers, TM-polarized modes exhibit stronger delocalization compared to transverse electric (TE) modes. The TM field places a smaller fraction of the total optical energy in the high-index SiN and a larger fraction in the surrounding oxide cladding. This redistribution increases the effective mode area and decreases local intensity within the SiN, thereby raising the damage threshold. The effect is especially beneficial at higher power levels, where TE modes remain more tightly confined and are thus more susceptible to nonlinear absorption and thermal stress.
(4) Strategic light splitting within thin SiN structures reduces downstream silicon stress. When an on-chip split is required, e.g., for polarization diversity or power sharing, performing the split within the thin SiN region provides a significant protective effect. By dividing the beam prior to entry into silicon, the optical intensity per branch is reduced by approximately 3 dB or more. This lowers the likelihood of damage in subsequent silicon sections, where nonlinear loss mechanisms such as two-photon absorption and free-carrier generation can otherwise occur. By combining thin-layer SiN guidance with early-stage splitting, SSC designs can maintain high coupling efficiency while safely managing optical inputs above 23 dBm.

In various embodiments, the present disclosure provides multiple complementary approaches, each of which may be implemented individually or in any combination, to enable reliable coupling between a high-powered laser (i.e., >20 dBm, and in certain cases >26 dBm) and a silicon photonics chip or die through a spot-size converter. These approaches include: (i) engineering thinner SiN guiding layers to reduce modal confinement and lower peak intensity, (ii) leveraging TM-polarized modes in such thin layers to broaden the effective mode area and distribute optical energy into the cladding, (iii) selectively implementing on-chip splitting within SiN to reduce downstream silicon stress and nonlinear absorption, and (iv) configuring one-step or two-step transitions (e.g., multi-rod-to-silicon or multi-rod-to-bridge-to-silicon) to further manage mode distribution and power density. Whether applied alone or in combination, these approaches provide scalable pathways for SSC architectures capable of sustaining high optical input powers beyond 26 dBm while maintaining low insertion loss, minimizing nonlinear penalties, and preventing permanent material damage.

### Coupling Changes

In one embodiment, conventional fiber coupling is replaced with a direct free-space optical connection between the semiconductor laser source and the silicon photonics chip. A two-lens imaging system, with a magnification ratio between approximately 1:1 and 1:3, is employed to reshape and relay the laser beam. By appropriate selection of lens focal lengths, the optical mode is transformed into a spot size having a mode-field diameter (MFD) in the range of about 3 μm to 10 μm at the chip input facet. This controlled MFD reduces the optical intensity per unit area compared to direct single-mode fiber coupling, thereby lowering the risk of localized damage in the spot-size converter. An optical isolator positioned between the two lenses further protects the laser from deleterious back-reflections that could otherwise destabilize or damage the source. In configurations where improved damage tolerance is achieved by operating in TM polarization, as described in Key Insight (3), a half-wave plate may be placed at the isolator output to rotate the native TE-polarized laser emission into TM polarization before entry into the SSC. Collectively, this free-space imaging arrangement provides a robust and flexible coupling scheme capable of reliably delivering laser powers exceeding 20 dBm (and up to and beyond 26 dBm) without compromising SSC integrity or device performance.

In another embodiment, a fiber-based coupling strategy is employed. If the SSC is smaller than the PM fiber mode, a high-numerical-aperture (HNA) fiber is spliced to a PM fiber pigtail for direct interfacing with the SSC. The HNA fiber exhibits a smaller mode-field diameter in the range of about 3 μm to 6 μm, which increases slightly the optical density at the SSC input relative to standard SMF. Furthermore, when TM polarization operation is desired for enhanced damage tolerance, the PM fiber is oriented such that its stress rods align to deliver vertically polarized light at the SSC input facet. This configuration ensures that the high-power optical mode is both spatially optimized and polarization-optimized to minimize intensity confinement in the high-index waveguide core.

The 3 μm to 6 μm MFD range is provided as one illustrative example. Other spot sizes, including smaller or larger MFDs, may be selected depending on laser characteristics, SSC geometry, and overall system requirements. The present disclosure therefore contemplates a broad range of free-space and fiber-based coupling modifications, each of which may be used individually or in combination with the SSC architectures disclosed herein to extend power-handling capability while maintaining low insertion loss and robust optical performance.

### TM Mode

As noted in Key Insight (3), the use of TM polarization significantly increases the power-handling capability of spot-size converters. This effect has been empirically validated using a baseline multi-rod structure SSC design. Comparative experiments conducted across multiple telecom bands, e.g., including the C-band, L-band, and O-band, demonstrated that SSCs configured for TM-polarized operation consistently achieved an elevated damage threshold relative to their TE-mode counterparts. In particular, the TM-mode configuration provided an improvement on the order of 1-2 dB before the onset of irreversible waveguide degradation.

The observed robustness advantage arises from the inherent modal properties of TM polarization in thin SiN rods. TM-polarized modes exhibit a broader spatial distribution and a reduced confinement factor in the high-index SiN core compared to TE-polarized modes. As a result, peak optical intensity is lowered, and a greater fraction of the optical field is dispersed into the surrounding cladding region, where energy can be more effectively dissipated without inducing localized heating or nonlinear absorption.

While fabrication-process variations (e.g., rod width, thickness, or etch uniformity) can influence the exact improvement margin, repeated wafer runs and device geometries have confirmed the trend: TM-polarized SSCs are less susceptible to thermal accumulation, nonlinear loss, and permanent structural damage at elevated input powers (>20 dBm, and up to and beyond 26 dBm). These findings establish TM polarization as a key enabling mechanism for extending the operational range of SSCs in high-power silicon photonics applications.

### Hybrid SSC and Splitter

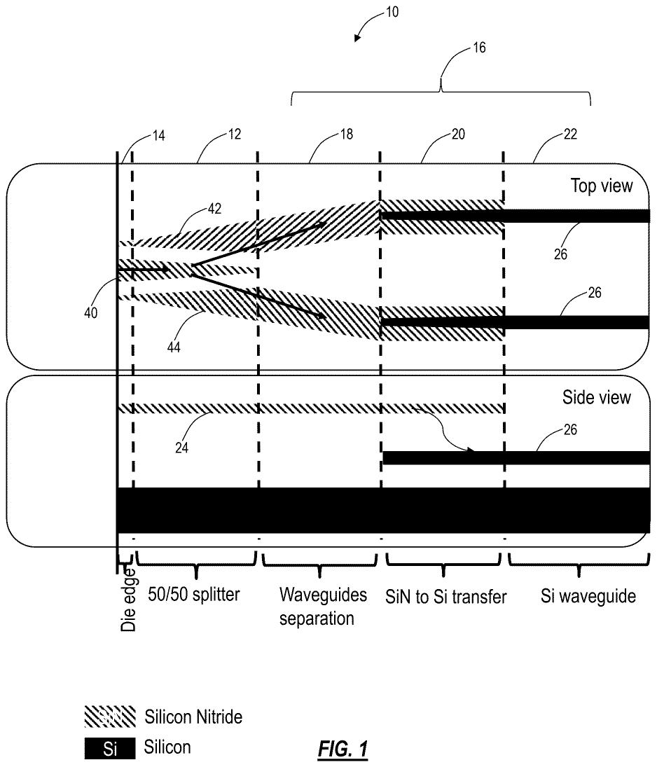

FIGS. 1-6 illustrate exemplary embodiments of a silicon photonics chip 10 incorporating an on-chip splitter 12 positioned at or near a chip facet 14 to divide an incoming high-power optical signal before it propagates through a spot-size converter (SSC) 16. Each embodiment demonstrates how splitter placement at the facet reduces the optical power density entering the SSC, thereby mitigating thermal, nonlinear, and damage effects. In general, the SSC 16 includes (i) a waveguide separation section 18 that routes the splitter outputs into distinct paths, (ii) a transfer section 20 that transitions the optical fields from silicon nitride (SiN) guiding structures into silicon (Si), and (iii) a downstream Si waveguide section 22 that carries the coupled light into functional circuitry of the chip. Across FIGS. 1-6, different material stacks (single- or multi-layer SiN) and transition geometries are illustrated to demonstrate various approaches to mode tailoring, power handling, and fabrication tolerance.

FIG. 1 illustrates a baseline embodiment in which the splitter 12 and SSC 16 are realized using a single SiN layer 24 that transitions into a Si layer 26 at the output of the SSC. At the chip facet 14, the incoming optical field is coupled into a three-rod SiN splitter structure including a center rod 40 and two outer rods 42, 44. The splitter region is designed with an adiabatic geometry such that the center rod 40 gradually narrows while the outer rods 42, 44 widen. This controlled taper causes the guided optical mode to evolve smoothly from a single composite mode at the facet into two well-defined modes carried by the outer rods. These two split beams are then directed into the waveguide separation section 18, where they are spatially separated and prepared for transfer into silicon.

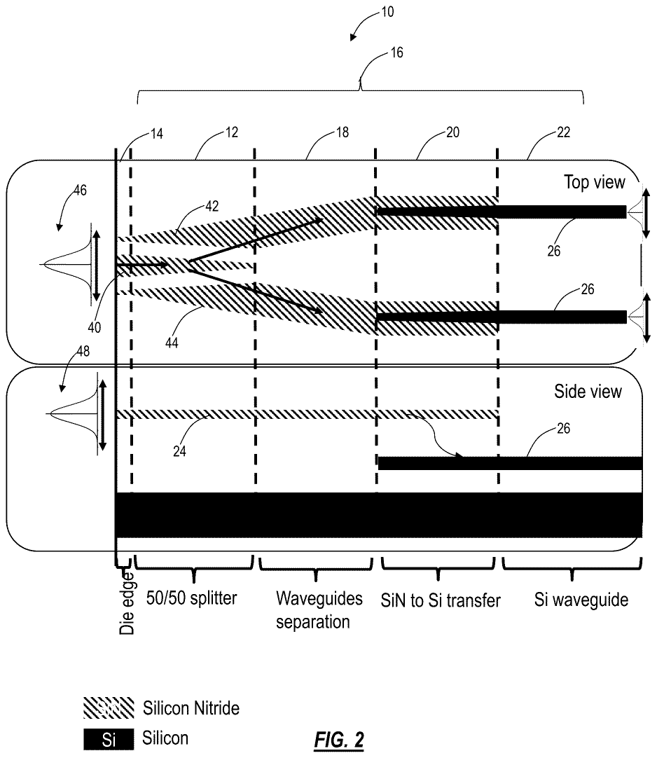

Downstream, the separated beams enter the SiN-to-Si transfer section 20, where adiabatic evanescent coupling transfers each mode from its SiN rod into the underlying Si layer 26. The Si waveguide section 22 then carries the split signals into the active or passive photonic circuits of the chip. This embodiment demonstrates the fundamental concept of facet-level splitting, in which high-power input light is divided immediately upon entry to the chip, reducing the per-path optical power by approximately 3 dB. This reduction protects subsequent silicon sections from excessive intensities, while maintaining low insertion loss and balanced splitting. FIG. 1 therefore establishes the reference case against which the more advanced multi-layer or bridged designs of FIGS. 2-6 may be compared.

FIG. 2 illustrates a refinement of the baseline configuration of FIG. 1, emphasizing both tolerance robustness at the facet 14 and representative coupling performance under misalignment. As in FIG. 1, the on-chip splitter 12 is realized within a single silicon nitride (SiN) layer 24 positioned at or near the chip facet 14, and transitions into a silicon layer 26 via the transfer section 20. The splitter region again employs a three-rod geometry including a center rod 40 and two outer rods 42, 44, arranged such that the center rod gradually narrows while the outer rods expand to form two adiabatic output branches. This geometry ensures an approximately 50/50 power split that reduces the downstream intensity entering the waveguide separation section 18 and Si waveguide section 22.

Distinctively, FIG. 2 includes tolerance plots adjacent to the chip facet 14, schematically depicting how lateral or angular deviations of the incident optical beam impact coupling efficiency and splitting ratio. The upper inset graph (labeled as input beam alignment 46) illustrates the nominal coupling profile when the incident beam is centered, while the lower inset graph (labeled as misaligned input beam 48) shows the modified coupling profile when the beam is shifted laterally. These representative plots demonstrate that the three-rod splitter configuration maintains a balanced split and low insertion loss over a range of input offsets. This condition can be met by optimizing the splitting section 12 and separation section 18 lengths. This tolerance to misalignment is particularly important for practical packaging, where variations in fiber placement, lens positioning, or assembly tolerances could otherwise degrade performance.

By comparison, earlier two-rod designs (omitting center rod 40) were found to be highly sensitive to sub-micron beam displacements, resulting in unpredictable split ratios and increased insertion loss. The inclusion of the center rod 40 in the three-rod design introduces a self-balancing mechanism that smooths the adiabatic transition, thereby stabilizing performance across typical fiber-to-chip assembly tolerances.

Accordingly, the embodiment of FIG. 2 not only reduces the optical intensity per path by performing a facet-level split, but also provides robust misalignment tolerance, ensuring reliable operation in manufacturing and field deployments. This makes the FIG. 2 design particularly advantageous for high-volume applications such as pluggable datacom and telecom transceivers, where assembly tolerances must be forgiving without compromising high-power performance.

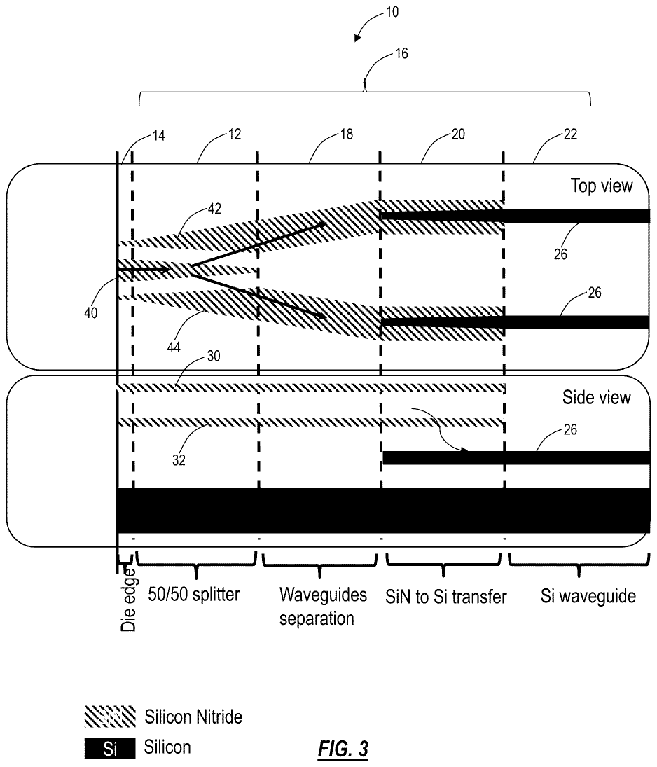

FIG. 3 illustrates an embodiment of the silicon photonics chip 10 in which the splitter 12 and the SSC 16 are implemented using two stacked SiN layers 30, 32 instead of a single SiN guiding layer. The two-layer approach provides enhanced flexibility in tailoring the effective mode size and distribution, thereby improving the power-handling capability of the SSC under high optical input conditions.

At the chip facet 14, the incoming light couples into a three-rod splitter structure similar to that described in FIGS. 1 and 2, with a center rod 40 that gradually tapers and two outer rods 42, 44 that expand to carry the split outputs. However, unlike the single-layer embodiment, the optical mode in FIG. 3 is supported jointly by the two SiN layers 30, 32, which are vertically separated and carefully designed to guide overlapping field components. This configuration enables more spatial delocalization of the guided mode, reducing the optical intensity in any one layer and thereby raising the damage threshold.

The splitter outputs are directed into the waveguide separation section 18, where they are physically routed into distinct paths. Because both the upper and lower SiN layers 30, 32 contribute to the guiding, the mode remains more broadly distributed and less tightly confined than in the single-layer case. Downstream, the two SiN layers transition through the transfer section 20 into the underlying silicon waveguide layer 26. This two-step SiN-to-Si transition enables smoother adiabatic coupling and can be optimized to minimize insertion loss while maintaining balanced power distribution between the outputs.

A key advantage of this two-layer embodiment is its ability to accommodate higher input powers (>22-26 dBm and beyond) by leveraging the increased effective mode area. The dual SiN layers reduce the fraction of the optical field confined within any single high-index layer, thereby lowering the risk of localized heating, nonlinear absorption, or catastrophic failure. In addition, the geometry allows designers to vary the thickness or refractive index contrast of each SiN layer independently, offering a further degree of freedom for mode shaping and polarization optimization.

Thus, FIG. 3 demonstrates how the use of multiple SiN layers in both the splitter 12 and SSC 16 can extend the operating range of silicon photonics chips under high-power illumination, while preserving the benefits of facet-level splitting and robust mode transfer into silicon circuitry.

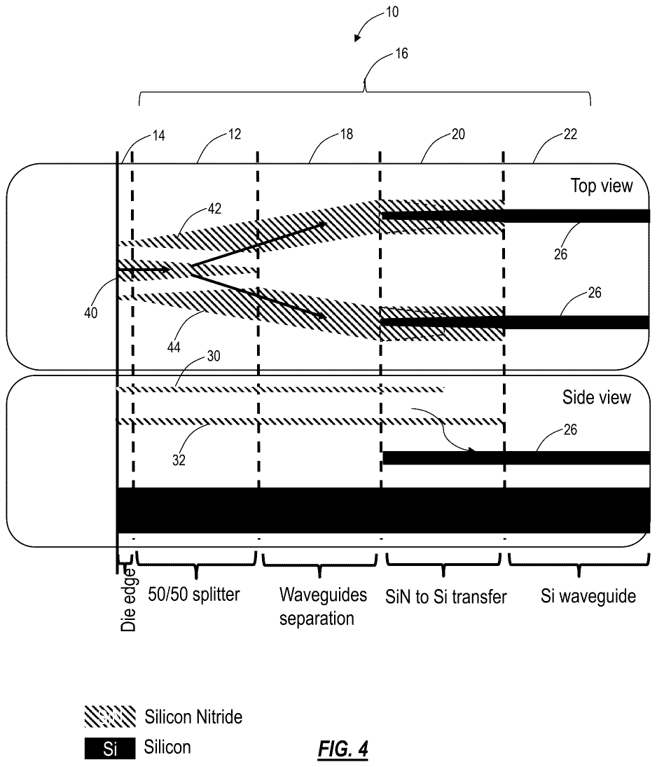

FIG. 4 illustrates a further embodiment of the silicon photonics chip 10 that, like FIG. 3, employs two stacked silicon SiN layers 30, 32 for the splitter 12 and SSC 16. However, in this embodiment the design specifically modifies the SiN-to-Si transfer section 20 in order to alter the adiabatic coupling profile into the underlying silicon waveguide 26. At the facet 14, the splitter 12 again uses a three-rod geometry with a center rod 40 and two outer rods 42, 44. The incoming mode is gradually evolved into two outputs, which are directed into the waveguide separation section 18. Here, both the upper and lower SiN layers 30, 32 participate in guiding the optical field, producing a broader mode distribution that lowers the optical intensity in any one material layer compared with the single-layer case of FIGS. 1 and 2.

In contrast to FIG. 3, however, the transfer section 20 in FIG. 4 is re-engineered to couple the optical modes into the silicon waveguide 26 using a different adiabatic pathway. Rather than maintaining full parallel overlap of both SiN layers throughout the transition, the two layers 30, 32 taper at different rates, with one layer handing off more quickly into the silicon core while the other maintains extended guiding. This staged handoff changes the effective refractive index profile encountered by the optical mode, allowing designers to finely control the balance between insertion loss, mode symmetry, and power density.

This arrangement provides multiple benefits:
(1) It enables tailored mode compression into silicon that can be matched to the application's tolerance for nonlinear loss.
(2) It allows designers to deliberately bias how much of the optical power couples first into silicon versus remaining temporarily in SiN, which can help balance damage thresholds across different material regions.
(3) It introduces additional degrees of freedom for polarization control, as the two SiN layers can be engineered with slightly different thicknesses or indices to preferentially support either TE or TM operation during the transition.

Thus, FIG. 4 demonstrates how modifying the two-layer SiN-to-Si transfer section 20 alters the adiabatic coupling dynamics in a way that enhances robustness and provides more control over insertion loss and nonlinear effects. This design is particularly useful when the SSC must operate across multiple wavelength bands or under extremely high input powers (>26 dBm), where fine-tuning of mode evolution is required to maintain reliable performance.

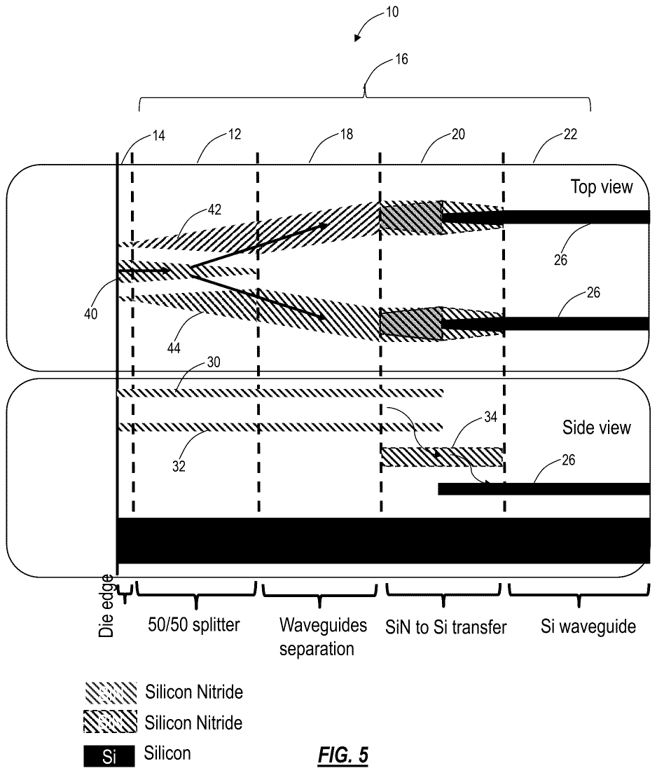

FIG. 5 illustrates another embodiment of the silicon photonics chip 10, which builds upon the two-layer SiN design of FIGS. 3 and 4 by incorporating a thicker SiN bridge layer 34 within the transfer section 20. The splitter 12 at the facet 14 continues to employ a three-rod configuration, with a center rod 40 and outer rods 42, 44, for adiabatically dividing the incident optical mode into two balanced outputs. These outputs are directed into the waveguide separation section 18 and then into the SiN-to-Si transfer region.

In this embodiment, the bridge layer 34 is positioned between the stacked SiN layers 30, 32 and the underlying silicon waveguide 26. The bridge layer has a thickness greater than that of the thin SiN rods, creating an intermediate refractive index step between the SiN guiding layers and the silicon substrate. This structure provides multiple functional advantages: (1) Mode positioning and reduced two-photon loss—The thicker silicon nitride (SiN) bridge layer 34 draws the guided optical mode lower and into closer proximity to the silicon waveguide 26 while remaining primarily supported in SiN. This proximity enables a shorter evanescent transfer section, thereby reducing the interaction length in high-index silicon during hand-off and lowering two-photon absorption (TPA) and associated free-carrier effects in the silicon section.

(2) Improved TM-mode transfer efficiency—The bridge layer 34 enhances adiabatic coupling of TM-polarized modes between the SiN rod layers 30, 32 and the silicon waveguide 26. Absent the bridge, the small tip widths of the silicon taper and SiN rods can induce incomplete evanescent transfer and excess insertion loss, particularly for TM polarization. The bridge provides an intermediate effective-index transition (“landing zone”) that relaxes taper-tip constraints and mitigates TM-specific transfer loss.

Thus, the embodiment of FIG. 5 demonstrates how the addition of a thicker SiN bridge layer 34 enhances the scalability of SSC designs to ultra-high-power applications. By combining facet-level splitting, dual SiN guiding layers, and a bridge-assisted transfer section, the device achieves a well-controlled mode evolution that supports efficient coupling into the silicon platform while significantly raising the damage threshold.

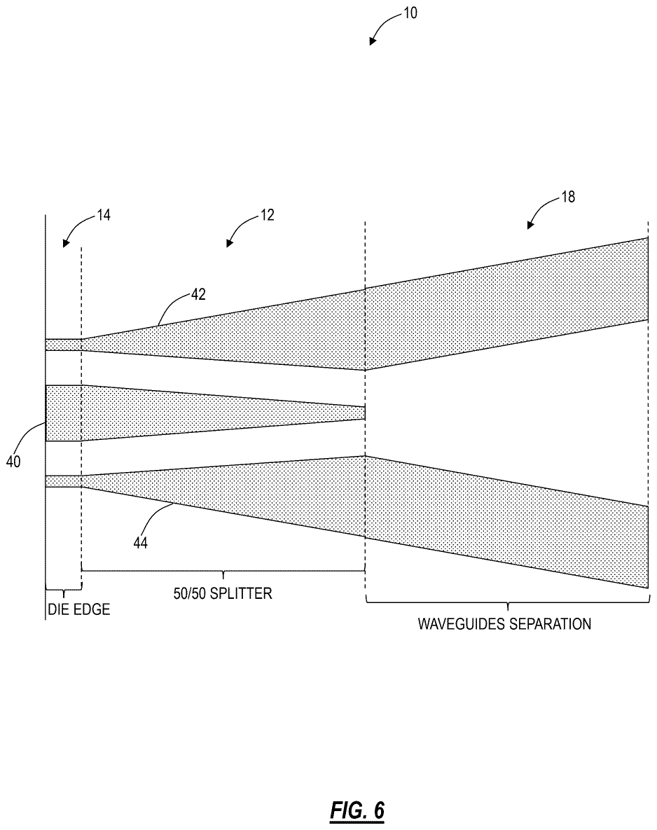

FIG. 6 provides a detailed close-up view of the chip facet 14 and the physical arrangement of the splitter 12, waveguide separation section 18, and related structures in the silicon photonics chip 10. This figure emphasizes the geometric layout of the three-rod splitter design at the facet and illustrates how the optical field is divided immediately upon entry into the chip. The waveguides separation 18 is usually performed with S-bend waveguide type, well-known in integrated optics.

At the facet 14, three SiN rods are positioned in parallel: a center rod 40 flanked symmetrically by two outer rods 42 and 44. The center rod 40 is widest at the facet entrance and gradually narrows as it extends into the splitter region, while the outer rods 42, 44 start narrow and gradually widen. This arrangement ensures that the composite input mode, when launched from an external fiber or free-space coupler, is initially shared across all three rods but adiabatically evolves into two balanced outputs in the outer rods 42, 44.

The waveguide separation section 18 extends from the termination of the splitter 12. In this section, the two outer rods 42, 44 diverge laterally to provide sufficient spacing between the two optical paths, thereby reducing unwanted crosstalk or coupling. The center rod 40 is effectively tapered out of the guiding region, ensuring that no residual optical power remains in the central path. The outputs of the separation section are then routed toward the transfer section 20 (not explicitly shown in detail in this close-up) for eventual coupling into the silicon waveguide 26.

The embodiment of FIG. 6 highlights the facet-level implementation of the splitter 12, showing that it can be fabricated with a compact, lithographically defined rod arrangement. This design provides multiple technical benefits:
(1) It ensures that the high-power optical beam is split immediately upon chip entry, reducing downstream intensity by ~3 dB per branch.
(2) The gradual, adiabatic transitions of rods 40, 42, 44 minimize insertion loss and imbalance between the split outputs.
(3) The lateral separation of outputs in the waveguide separation section 18 allows for straightforward integration into polarization-diverse circuits or parallel functional blocks within the chip.

This close-up view confirms that the three-rod configuration provides a more robust and predictable 50/50 splitting performance compared to two-rod geometries, which tend to exhibit greater sensitivity to alignment errors. The geometry shown in FIG. 6 can also be scaled to implement higher-order 1×n splitters by introducing additional pairs of rods and separation stages, extending the same principle of facet-level power division to more complex SSC architectures.

### Silicon Photonics Device

In an embodiment, a silicon photonics device for coupling high-power optical signals includes a chip facet configured to receive an input optical signal; a splitter positioned at or near the chip facet and including at least two waveguide elements of SiN arranged to divide the input optical signal into at least two sub-signals; a waveguide separation section in optical communication with the splitter, said waveguide separation section guiding the at least two sub-signals away from one another; and a respective SSC configured to receive each sub-signal from the waveguide separation section. The SSC can include a SiN waveguiding region arranged to expand or reshape an optical mode of the sub-signal, and a silicon waveguide in optical communication with the SiN waveguiding region. The SSC facilitates an adiabatic transfer of the sub-signal into the silicon waveguide. The silicon waveguide may include a taper. The splitter, waveguide separation section, and the SSC are collectively configured to reduce a local optical power density on the silicon photonics device so as to withstand laser inputs exceeding 20 dBm without incurring permanent waveguide damage.

The splitter can be configured as a 50/50 beam splitter with three SiN rods, a center rod that narrows adiabatically, and two outer rods that widen adiabatically, thereby equally distributing the input optical signal into two sub-signals. Each of the three SiN rods can have a thickness of less than 100 nm, thereby facilitating a larger effective optical mode area in silicon nitride to reduce optical intensity. The device can further include a bridge waveguide of silicon nitride between the splitter and the silicon waveguide, the bridge waveguide having an intermediate refractive index profile that further expands or contracts the optical mode before transferring it into the silicon taper.

The SSC can be configured to operate in a TM polarization, causing the optical mode to delocalize more strongly in the silicon nitride waveguiding region and thereby increasing the power damage threshold relative to TE polarization. The facet can be further arranged to accommodate an HNA fiber pigtail, such that the input optical signal features a mode-field diameter of about 3-10 μm at the chip facet, thereby lowering the optical power density at the splitter.

The facet can be configured for free-space coupling through a two-lens imaging system providing a 1:1 to 1:3 magnification, and the device further comprises a polarization control element or half-wave plate to rotate an incoming laser polarization from TE to TM before entering the splitter. The SSC can include a multi-level silicon nitride structure with at least two distinct SiN layers stacked vertically to accommodate higher-power modes and enhance the coupling transition into the silicon taper.

The device can further include at least one additional splitter cascaded downstream of the splitter at the chip facet, each additional splitter arranged to divide a sub-signal into multiple waveguides and thereby reduce local optical intensity for subsequent photonic elements. The SSC and splitter can be designed to accommodate input powers of at least 22.5 dBm, as demonstrated by empirical testing showing negligible waveguide damage or permanent defects in the silicon nitride or silicon taper regions.

### Small MFD SSC

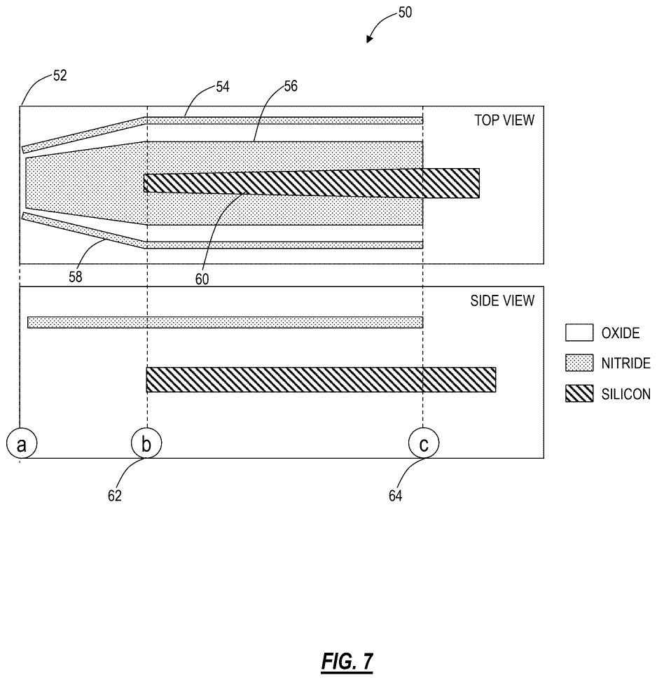

FIG. 7 illustrates an embodiment of a small mode-field diameter (MFD) spot-size converter (SSC) 50, designed to accommodate high-power optical inputs while minimizing localized damage. Consistent with Key Insight (2), which emphasizes the use of thin silicon nitride (SiN) layers (<100 nm) to reduce peak power density, this SSC architecture has been experimentally validated to withstand continuous-wave input levels exceeding 22.5 dBm. The design thereby confirms that a reduced MFD at the input, coupled with controlled adiabatic expansion, elevates the overall damage threshold compared to conventional thicker-layer implementations.

At the facet input 52 (position a), the SSC 50 includes a three-rod SiN arrangement 54, 56, 58, which collectively guide and initially confine the incoming optical mode. The three rods are arranged to expand the mode gradually, ensuring that the guided light is sufficiently delocalized in the SiN region before reaching the silicon transition. The silicon taper 60 begins at the transfer region 62 (position b), where the effective indices of the SiN rods and the Si taper overlap. In this transitional region, an adiabatic evanescent coupling process occurs, enabling smooth transfer of the optical mode from the SiN rods into the silicon taper. By the time the optical mode reaches the fully silicon-guided region 64 (position c), the transition is complete, and the light is confined within the silicon core.

In practical operation, the SSC 50 transitions the optical mode from an initial effective area of greater than approximately 2.5 μm² in SiN to about 0.15 μm² in Si for TE polarization, and from greater than approximately 7.5 μm² in SiN to about 0.2 μm² in Si for TM polarization. The broader initial mode, e.g., especially for TM operation, reduces the local optical intensity at each point along the SSC, thereby increasing the damage threshold for high-power applications.

The three-rod arrangement 54, 56, 58 further enhances fabrication tolerance, maintaining consistent coupling efficiency despite lithographic variations or small alignment deviations at the facet input 52. This tolerance ensures reliable performance across wafer runs and packaging processes. In alternative embodiments, a single-rod configuration or a two-rod configuration may be used when fabrication precision is higher or when different beam-shaping characteristics are desired.

Overall, the small-MFD SSC 50 demonstrates how thin SiN waveguides combined with carefully engineered adiabatic transitions enable robust handling of laser input powers greater than 20 dBm without introducing excess insertion loss or compromising downstream silicon photonics performance.

### Other Embodiments

In addition to the 1×2 splitter embodiments shown in FIGS. 1-6, other splitter configurations are also contemplated, including but not limited to 1×3, 1×4, or higher-order 1×n (n is a positive integer) splitters, consistent with the various SSC approaches described herein. The on-chip splitter serves two fundamental functions. First, it reduces the optical power per branch by dividing the incoming high-power beam into multiple outputs, thereby lowering the local intensity experienced by downstream silicon photonics waveguides and mitigating the risk of nonlinear absorption or material damage. Second, it generates multiple signal copies that may be routed independently within the photonic integrated circuit, enabling parallel signal processing or multi-functional architectures.

For example, in the case of a 1×2 splitter, the two copies may be used for polarization-diverse receiver circuits, where one branch processes the TE-polarized component and the other processes the TM-polarized component. Alternatively, one copy may be directed to a coherent receiver as a local oscillator (LO), while the other is routed to an electro-optic modulator to seed a transmitter. In both cases, the 50/50 division simultaneously reduces the optical power in each path by approximately 3 dB, while providing the dual outputs required for system functionality.

In more advanced configurations, such as a 1×4 splitter, the architecture can support applications that require multiple identical optical carriers. These include, for example, (i) driving the four arms of cascaded Mach-Zehnder interferometer (MZI) modulators in high-baud-rate transmitters, (ii) distributing a strong LO signal to multiple coherent receiver channels in spatial-division multiplexing or multi-wavelength systems, or (iii) providing redundant optical copies for monitoring, calibration, or error-correction subsystems. By dividing the input into four branches, the per-branch power is reduced by approximately 6 dB, greatly increasing the survivability of downstream silicon waveguides while still delivering usable high-power copies.

In general, the splitter design can be scaled to 1×n outputs by extending the three-rod geometry of FIG. 6 or introducing cascaded stages. Each additional stage reduces the power per branch, balancing high-power survivability with the functional requirement for multiple identical copies of the same signal. This makes the facet-level splitter architecture highly versatile for datacom, telecom, and coherent optical applications, where both power management and signal replication are critical to reliable system performance.

### 1×4 Splitter—Two Stage Approach 1

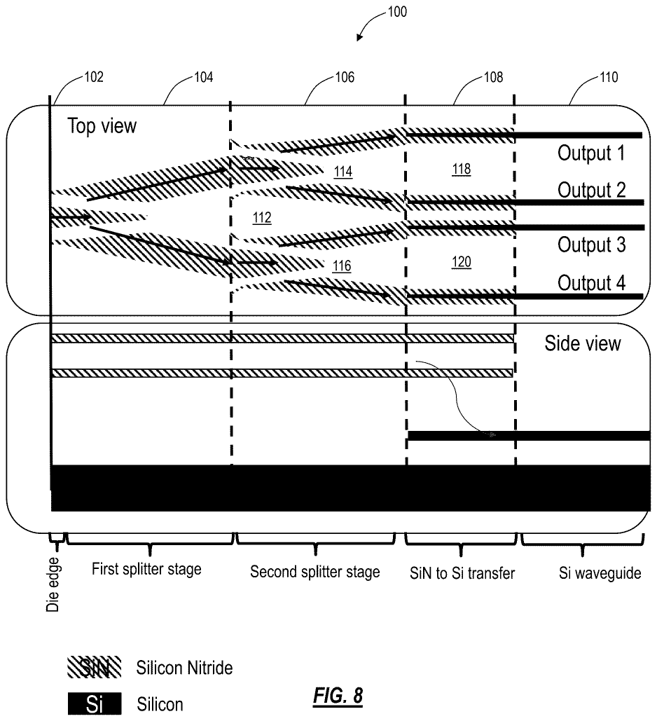

FIG. 8 illustrates an embodiment of a silicon photonics chip 100 implementing a 1×4 splitter 112 realized through two cascaded splitting stages. This embodiment demonstrates how higher-order facet-level splitting may be achieved by extending the 1×2 splitter architectures of FIGS. 1-6. The chip 100 includes a die edge 102, at which a high-power optical beam is launched into the splitter 112. The beam is first divided in a first splitter stage 104, where the input is separated into two outputs using a three-rod adiabatic transition similar to the previously described geometries. These two outputs are then directed into a second splitter stage 106, in which each branch is further split into two additional outputs, thereby yielding four total branches at the output of the second stage. In this embodiment, adjacent input waveguides 114, 116 are introduced adiabatically into the second splitter stage 106 to avoid perturbation of the mode profile exiting the first splitter stage 104, thereby preserving balance and minimizing excess insertion loss.

Downstream of the splitting stages, the four SiN-guided modes are transitioned through a SiN-to-Si transfer stage 108, which couples the optical fields into the underlying silicon waveguides 110. The waveguide separation sections 118, 120 provide physical spacing between the branches to reduce crosstalk and enable independent routing of each copy into distinct functional circuits on the chip. The cascaded 1×4 splitter 112 provides two critical advantages. First, it reduces the per-branch optical power by approximately 6 dB, ensuring that downstream silicon waveguides experience lower optical intensities and are thus protected from nonlinear absorption and permanent damage. Second, it generates four identical copies of the input signal, enabling a wide range of system-level functions. For example, each copy may be routed to one arm of a MZ modulator array, supplied as LO signals to multiple coherent receiver channels, or reserved for calibration and monitoring.

While FIG. 8 illustrates a two-stage architecture yielding four outputs, the principle may be extended to additional cascaded stages, producing 1×n splitters (n>4) by repeating the geometry. Each additional stage provides further power division and additional signal copies, while maintaining adiabatic transitions that safeguard mode quality and minimize loss.

### 1×4 Splitter—Two Stage Approach 2

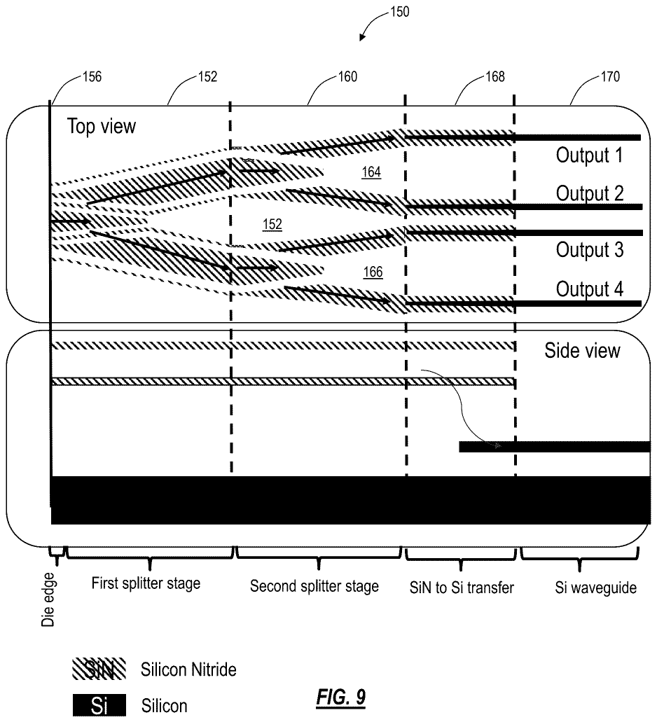

FIG. 9 illustrates an embodiment of another silicon photonics chip 150 implementing a 1×4 splitter 152 realized through two cascaded splitting stages. Unlike the design of FIG. 8 (chip 100), in which adjacent waveguides are introduced adiabatically at the entrance to the second stage, in the chip 150 all adjacent waveguides are already present at the first stage entrance at a die edge 156. This configuration ensures that the optical modes are co-propagating from the beginning of the splitter section, thereby reducing perturbations and simplifying adiabatic handoff between stages.

At the die edge 156, the incoming high-power optical signal is launched into the first splitter stage 158, where a three-rod adiabatic geometry divides the mode into two balanced outputs. Immediately downstream, the outputs are directed into a second splitter stage 160, where each branch is further divided, resulting in four total outputs. Because all adjacent waveguides are present from the beginning of the splitter, the mode evolution is smoother, and crosstalk between neighboring paths is minimized.

The four outputs from the splitter 152 are routed through SiN waveguide separation sections 164, 166, which provide sufficient lateral spacing to reduce evanescent coupling and allow for independent routing of each signal copy. These outputs are then transitioned through a SiN-to-Si transfer stage 168, where adiabatic coupling transfers the optical modes into the underlying silicon waveguides 170. Each silicon waveguide 170 carries one of the four reduced-power optical signals for subsequent use in downstream photonic circuitry.

The embodiment of FIG. 9 provides both power reduction (by approximately 6 dB per branch relative to the input) and signal replication, creating four identical optical copies. Use cases include feeding multiple Mach-Zehnder modulator arms in high-baud-rate transmitters, supplying local oscillator signals to multiple coherent receiver channels, or providing redundant optical signals for monitoring and calibration. By ensuring that all waveguides are co-present at the first stage entrance at the die edge 156, the design achieves greater uniformity in splitting ratio and improved tolerance to fabrication variations compared to cascaded designs where waveguides are introduced later.

### 1×4 Splitter—Single Stage Approach

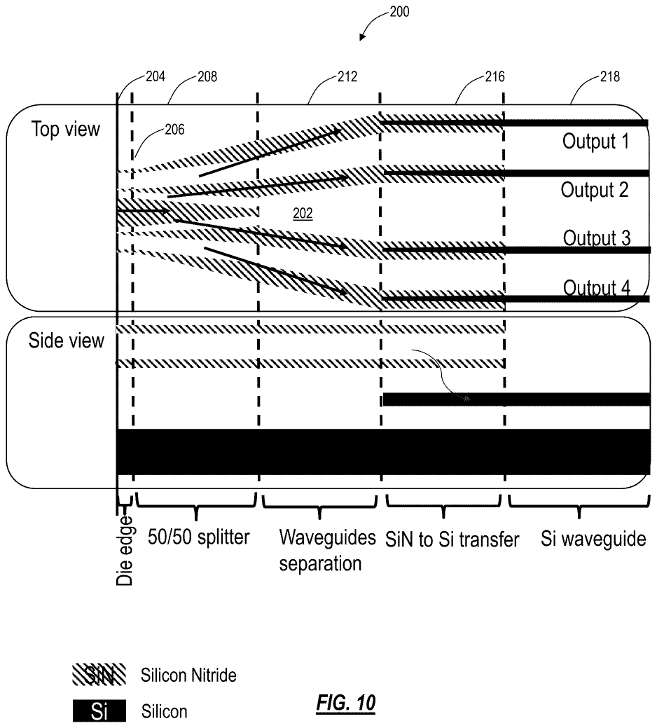

FIG. 10 illustrates an embodiment of a silicon photonics chip 200 implementing a 1×4 splitter 202 realized through a single-stage splitting architecture. In this embodiment, the full four-way split is performed at the chip facet 204 without requiring cascaded splitter stages, as in the embodiments of FIGS. 8 and 9.

At a die edge 206, the input optical beam is launched into a multi-rod splitter section 208. Unlike the two-stage designs, the splitter section 208 incorporates multiple rods at the input to directly divide the incoming mode into four distinct branches in a single adiabatic transition. The geometry is arranged such that the central rods taper to narrow widths while the outer rods widen, gradually redistributing the input mode evenly across all four outputs. This ensures that each branch receives approximately 25% of the incident optical power, corresponding to a ~6 dB reduction relative to the input.

Downstream of the splitter 208, the optical paths are routed through waveguide separation sections 212, which provide lateral spacing between the four outputs to minimize crosstalk and enable independent routing. Each separated branch then couples into a SiN-to-Si transfer section 216, where the optical fields are adiabatically transferred from the SiN rods into the underlying silicon waveguides 218. The resulting four silicon outputs may be independently routed to downstream functional photonic circuits.

The single-stage splitter 202 offers a more compact footprint compared to cascaded two-stage designs, which can simplify layout and reduce insertion loss. However, the design imposes stricter requirements on fabrication and alignment tolerances, as the adiabatic four-way split must be carefully engineered to maintain balance across all outputs. This architecture is well-suited for applications requiring multiple identical high-power signal copies, such as distributing local oscillator signals to multiple coherent receiver channels, driving multi-arm modulators, or generating redundant optical paths for monitoring and calibration.

### Process

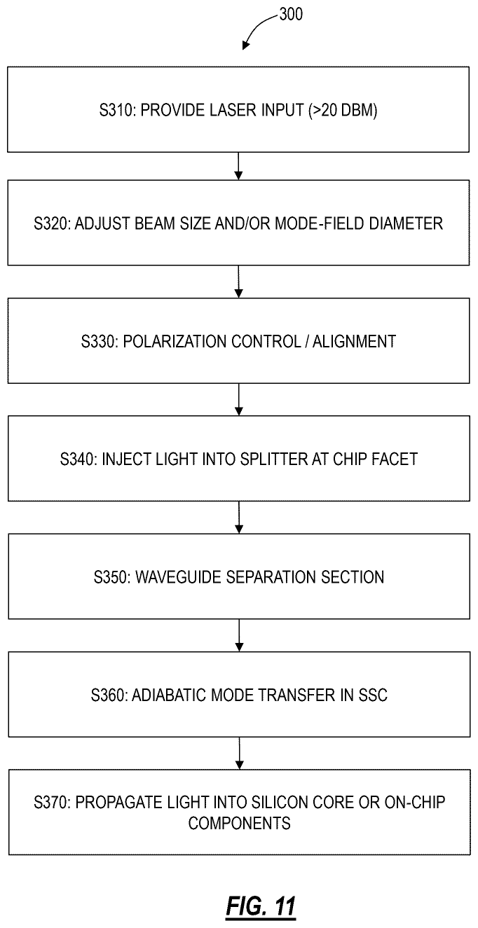

FIG. 11 illustrates a flowchart of a process 300 for operating a high-power spot-size converter (SSC) in a silicon photonics (SiPhot) device. Although specific step labels (e.g., S310, S320) are shown, the sequence is illustrative and can be adapted to suit different system implementations, design standards, or manufacturing constraints. Not all steps are strictly necessary; in practice, certain embodiments may include only a subset of the illustrated operations. The process 300 includes the following stages:

Step S310: Provide Laser Input (>20 dBm). A high-power optical signal is generated or supplied, typically in the 20-26 dBm range, and in some embodiments even higher for future data-center or coherent-optics applications. The laser input may originate from a discrete semiconductor laser, an external cavity laser, or another high-brightness source. Depending on the overall system design, the input may be delivered either by free-space optics (direct launch with lenses) or by fiber coupling (using single-mode or polarization-maintaining fibers).

Step S320: Adjust Beam Size and/or MFD. To avoid excessive optical intensity at the chip facet, the beam is reshaped into a controlled mode-field diameter of about 3-10 μm. This can be achieved by:
(1) Free-space lens imaging systems, typically configured with a 1:1, 1:2 or 1:3 magnification ratio to expand or contract the input beam; or
(2) PM or SM fiber pigtail or HNA fibers, spliced to a PM pigtail or standard single-mode fiber, which naturally provide a smaller effective MFD at the output.

Step S330: Polarization Control and Alignment. If higher damage tolerance is desired, the optical signal is launched in TM polarization, as identified in Key Insight (3). TM polarization produces a broader spatial distribution and a lower confinement factor within the SiN rods, thereby raising the effective damage threshold. Polarization control may be performed using:
(1) A half-wave plate in a free-space configuration, typically placed after an optical isolator; or
(2) Stress-rod alignment in a PM fiber, ensuring that the vertical axis of the fiber is aligned to launch TM polarization into the chip plane.

Step S340: Inject Light into Splitter at Chip Facet. The shaped and polarized beam is introduced at the chip facet 302, where an integrated splitter 304 is positioned. The splitter immediately divides the input beam, commonly into two equal 50/50 branches (though other ratios such as 70/30 or 25/25/25/25 are possible in multi-stage designs). This early division reduces the local power density in each branch by approximately 3 dB (for 1×2) or more in higher-order configurations.

Step S350: Route Through Waveguide Separation Section. Each split sub-signal is directed along diverging SiN waveguides 306, often realized as multi-rod or slab-like geometries. The separation provides physical spacing, suppresses unwanted coupling between branches, and prepares the optical modes for transition into silicon. This stage ensures that each sub-signal maintains integrity as an independent channel.

Step S360: Perform Adiabatic Mode Transfer in SSC. Within the SSC, the split signals are transferred from SiN waveguides 306 into silicon waveguides 308 via an adiabatic evanescent coupling region 310. This region is carefully engineered so that the effective indices of the SiN and Si cores intersect gradually, enabling smooth handoff of the optical field. Multi-rod SiN structures, thin-film layers (<100 nm), or SiN bridge layers may be employed to further distribute the mode and lower intensity during transfer. The adiabatic design minimizes insertion loss, suppresses back-reflections, and reduces nonlinear penalties.

Step S370: Propagate Light into Silicon Core and On-Chip Components. Following successful mode transfer, the optical signals propagate within the silicon waveguide cores 308 at safe power densities below the material damage threshold and with significant two-photon absorption loss reduction. From here, the signals can be routed to on-chip components 312, including Mach-Zehnder modulators, coherent receivers, switches, or photodetectors, depending on the application. This step completes the transition from high-power input coupling to fully integrated photonic circuit operation.

The combined effect of these steps provides multiple layers of protection against high-power damage. Immediate splitting (S340-S350) reduces per-branch power early. Thin SiN guiding layers and TM polarization (S330, S360) lower local optical intensities and mitigate thermal and nonlinear effects. Free-space lensing or HNA fiber coupling (S320) gives precise control over the beam profile, ensuring compatibility with varying laser sources. Together, these measures enable SSC designs that can reliably sustain input powers above 20 dBm and extending to 26 dBm and beyond, supporting next-generation datacom and coherent-optics applications.

### Conclusion

In the embodiments described herein, silicon nitride (SiN) and silicon (Si) are provided as representative examples of materials used for the splitter waveguide elements, guiding regions, and downstream waveguides of the spot-size converter. These materials are commonly employed in silicon photonics due to their favorable refractive index contrast, CMOS compatibility, and low propagation loss. However, the present disclosure is not limited to Si and SiN. Other dielectric or semiconductor materials are contemplated, including, but not limited to, silica, silicon oxynitride (SiON), indium phosphide (InP), gallium arsenide (GaAs), aluminum nitride (AlN), or hybrid material stacks. The selection of materials may be adapted based on wavelength band, fabrication platform, or desired optical performance. Accordingly, references to “Si” or “SiN” waveguide structures herein should be understood as illustrative, and not limiting, of the broader class of materials that can be used to realize the disclosed architectures.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A photonics device, comprising:
a chip facet configured to receive an input optical signal;
an integrated splitter, the splitter comprising a plurality of waveguide elements arranged to divide the input optical signal into a plurality of sub-signals;
a waveguide separation section optically coupled to the splitter and configured to route each of the plurality of sub-signals into distinct paths; and
a respective spot-size converter (SSC) in each of the distinct paths optically coupled to the waveguide separation section and comprising a guiding region and a waveguide, the SSC being configured to transfer a respective sub-signal of the plurality of sub-signals from the guiding region into the waveguide.

2. The photonics device of claim 1, wherein an input of the splitter supports a first optical mode having a first modal effective area and the waveguide supports a second optical mode having a second modal effective area, wherein the first modal effective area is larger than the second modal effective area.

3. The photonics device of claim 2, wherein the first modal effective area is an order of magnitude larger than the second modal effective area.

4. The photonics device of claim 1, wherein the input optical signal has a power greater than 20 dBm, and wherein the splitter and waveguide separation section reduce local optical intensity and generate multiple usable signal copies for downstream photonics components.

5. The photonics device of claim 1, wherein the splitter comprises a three-rod geometry including a center rod that narrows and two outer rods that widen, thereby producing two balanced outputs.

6. The photonics device of claim 1, wherein each waveguide element of the splitter has a thickness less than 100 nm, thereby broadening an effective optical mode area and reducing peak power density.

7. The photonics device of claim 1, wherein the SSC is configured to operate in transverse magnetic (TM) polarization, thereby delocalizing an optical mode more strongly in the guiding region relative to transverse electric (TE) polarization.

8. The photonics device of claim 1, further comprising a bridge waveguide positioned between the guiding region and the waveguide, the bridge waveguide having an intermediate refractive index profile.

9. The photonics device of claim 1, wherein the splitter comprises two or more vertically stacked layers configured to jointly guide an optical mode.

10. The photonics device of claim 1, wherein the splitter is configured as a 1×2 splitter, reducing per-branch power by about 3 dB and providing two usable optical copies.

11. The photonics device of claim 1, wherein the splitter is configured as a 1×4 splitter, reducing per-branch power by about 6 dB and providing four usable optical copies.

12. The photonics device of claim 9, wherein the four usable optical copies are routed respectively to four arms of a Mach-Zehnder interferometer (MZI) modulator array.

13. The photonics device of claim 9, wherein at least one of the four usable optical copies is routed to a coherent receiver as a local oscillator (LO) input.

14. The photonics device of claim 9, wherein at least one of the four usable optical copies is routed to a monitoring or calibration circuit.

15. The photonics device of claim 1, wherein the splitter is configured as a 1×n splitter, where n is an integer ≥2, produced through cascaded splitting stages.

16. The photonics device of claim 1, wherein the chip facet is configured to couple with either (i) a high-numerical-aperture (HNA) fiber having a mode-field diameter of about 3-6 μm, or (ii) a standard single-mode (SM) or polarization-maintaining (PM) fiber having a mode-field diameter adapted to the chip facet.

17. The photonics device of claim 1, wherein the integrated splitter is positioned at or proximate to the chip facet.

18. The photonics device of claim 1, wherein the device is configured to sustain optical inputs of at least 22.5 dBm.

19. A photonics device produced by a process, the process comprising:
forming a chip facet configured to receive an input optical signal;
fabricating an integrated splitter, the splitter including waveguide elements arranged to divide the input optical signal into a plurality of sub-signals;
fabricating a waveguide separation section coupled to the splitter to route each of the plurality of sub-signals into distinct paths; and
fabricating a respective spot-size converter (SSC) comprising a guiding region and a waveguide in each of the distinct paths, the respective SSC being configured to transfer each of the plurality of sub-signals into the waveguide.

20. A method of operating a photonics device, comprising:
providing a high-power optical signal to a chip facet of the device;
injecting the optical signal into an integrated splitter, the splitter dividing the optical signal into a plurality of sub-signals to reduce per-branch optical power in distinct paths;
routing each of the plurality of sub-signals through a waveguide separation section to reduce crosstalk and prepare the sub-signals for transfer;
performing a mode transfer of each sub-signal from a guiding region into a waveguide within a respective spot-size converter (SSC) in each of the distinct paths; and
propagating the sub-signals within the waveguide to downstream photonic components.
